(19) United States
(12) Patent Application Publication
(10) Pub. No.: US 2009/0045074 A1
(43) Pub. Date: Feb. 19, 2009

(54) APPARATUS AND METHOD FOR REMOVAL OF IONS FROM A POROUS ELECTRODE THAT IS PART OF A DEIONIZATION SYSTEM

(75) Inventors: Richard L. Hoover, Pueblo, CO (US); Brian B. Elson, Pueblo, CO (US); Brian C. Large, Pueblo, CO (US); Peter Norman, Pueblo West, CO (US)

Correspondence Address: DARBY & DARBY P.C., P.O. BOX 770, Church Street Station, New York, NY, 10008-0770, US

(73) Assignee: The Water Company LLC, Pueblo, CO (US)

(21) Appl. No.: 12/175,624

(22) Filed: Jul. 18, 2008

Related U.S. Application Data
(60) Provisional application No. 60/950,594, filed on Jul. 18, 2007.

(51) Int. Cl. B01J 19/08; C25B 11/12; C01B 31/02

(52) U.S. Cl. 205/687; 204/290.03; 204/290.05; 204/290.07; 204/242; 204/277; 264/29.1

(57) ABSTRACT

An electrode for use in a deionization apparatus includes a conductive material that is in a granular form and is arranged in a layer that is defined by a first face and a second face. The electrode includes a substrate that is disposed against the first face, and a first member that is disposed against the second face and is formed to permit a fluid to pass through the first member and into contact with the granular conductive material to permit absorption of ions by the granular conductive material.

This application claims priority under 35 U.S.C. § 119(e) to U.S. Provisional Patent Application Ser. No. 60/950,594, titled Apparatus and Method for Removal of Ions from a Porous Electrode that Is Part of a Deionization System, and filed on Jul. 18, 2007, which is hereby incorporated by reference as though set forth in its entirety.

### TECHNICAL FIELD

The present invention relates generally to an electrochemical separation system including an electrode for removing ions, holding, oxidizing and reducing contaminants and impurities from fluids, such as water, and other aqueous process streams. The invention further relates to a fluid treatment system (e.g., deionization system) using the same.

### BACKGROUND

There are a number of different systems for the separation of ions and impurities from fluid streams, such as water effluents or the like. For example, conventional processes include but are not limited to distillation, ion exchange, reverse osmosis, electrodialysis, electrodeposition and filtering. Over the years, a number of apparatuses have been proposed for performing deionization and subsequent regeneration of water effluents, etc.

One proposed apparatus for the deionization and purification of water effluents is disclosed in U.S. Pat. No. 6,309,532. The separation apparatus uses a process that can be referred to as capacitive deionization (CDI). In contrast to conventional processes, this technology does not require chemicals during the deionization process but rather, this system uses electricity. A stream of electrolyte to be processed, containing various anions and cations, electric dipoles, and/or charged suspended particles, is passed through a stack of electrochemical capacitive deionization cells during a deionization (purification) cycle. Electrodes in the cells attract particles or ions of the opposite charge, thereby removed them from solution.

Thus, the system is configured to perform deionization and purification of water influents and effluents. For example, one type of system includes a tank having a plurality of deionization cells that is formed of non-sacrificial electrodes of two different types. One type of electrode is formed from an inert carbon matrix of specific design (ICM). This electrode removes and retains ions from an aqueous solution when an electrical current is applied. The other type of electrode, formed from a conductive material, does not remove or removes fewer ions when an electric current is applied and therefore is classified as being non-absorptive (“non-ICM electrode”). This property is common to electrodes formed from carbon cloth, graphite, titanium, platinum and other conductive materials. The non-ICM carbon electrode is formed as a dual electrode in that it has a pair of conductive surfaces that are electrically isolated from one another.

Accordingly, in one embodiment, the apparatus includes a number of conductive, non-sacrificial electrodes each in the form of a flat plate, that together in opposite charge pairs form a deionization cell. During operation, a voltage potential is established between a pair of adjacent electrodes. This is accomplished by connecting one lead of a voltage source to one of the electrodes and another lead is attached to the electrodes that are adjacent to the one electrode to produce a voltage potential there between.

In order to construct a stable, robust ICM electrode, a reinforcer can be used to strengthen the high surface area absorptive material. Typically, the reinforcer is in the form of a carbon source, such as carbon felt, granular carbon or carbon fiber; however, it can also be in the form of a carbon/cellulose or carbon silica mixture. The carbon source is used as reinforcement in the formation of the electrode and while it can come in different forms, it is important that the carbon reinforcement be electrically conductive and not reduce the electrical conductance of the electrode. A carbon source is selected to permit the electrode to have the necessary conductive properties and must also be fully dispersed in the other materials that form the ICM electrode, namely a resorcinol-formaldehyde liquor, which then sets, or can absorb a similar quantity of the liquor in a matrix and then set.

The non-homogeneity of the prior art electrodes that contain fiber reinforcement affects its absorptive and electrical properties. More specifically, the use of carbon fibers as a carbon reinforcement provides fewer attachment sites for ions and the electrode also tends to be less balanced in the removal of positive and negative ions. Thus, it is desirable to produce a homogenous electrode that is robust and has increased reinforcement characteristics without the use of conventional fiber reinforcement.

In addition, the present Applicants have disclosed in copending U.S. patent application Ser. No. 60/827,545, (which is hereby incorporated by reference in its entirety) a system or apparatus for the deionization and purification of influents or effluents, such as process water and waste water effluents and more particularly, a non-sacrificial electrode that does not require carbon-fiber based reinforcement. Instead, the electrode is formed of a granular conductive carbon material electrode such that the electrode has a porous construction. The granular conductive carbon material is disposed within a layer that comes into contact with the fluid that is to be treated. As explained in the '545 application, the fluid treatment process involves performing a number of forward deionization operations or cycles before the electrodes are regenerated during a regeneration process or cycle. The timing of when the regeneration process is desired or required depends on a number of different parameters, including the type of fluid that is being treated, the length of the forward treatment cycles, etc. In a deionization system, one layer or collection of the granular conductive carbon material acts as the anode and another layer or collection of granular conductive carbon material acts as the cathode. However, over time and due to the porous nature of the anode and cathode electrodes, respective ions can build up in the granular conductive carbon material of both the anode and cathode. The present Applicants have discovered that such ion build up in the form of interstitial fluid can adversely affect the effectiveness of the deionization process and the performance of the system.

### SUMMARY

In one aspect of the present invention an electrode for use in a deionization apparatus is provided. The electrode includes a conductive material that is in a granular form and is arranged in a layer. A substrate is disposed against a first face of the electrode and a fluid permeable member material is disposed against the second face of the electrode and is formed to permit a fluid to be treated pass through the fluid permeable member and into contact with the granular conductive.

In accordance with a further aspect of the present invention, the granular conductive material comprises a polymerization monomer; a crosslinker; and a catalyst, and optionally reaction products thereof, in a carbonized form that is processed into a plurality of particles. Optionally, the polymerization monomer includes at least one material from the group consisting of dihydroxy benzenes; trihydroxy benzenes; dihydroxy naphthalenes and trihydroxy naphthalenes, furfural alcohol and mixtures thereof.

In yet a further aspect of the present invention a method of regenerating oppositely charged electrodes of the type discussed above for use in a deionization apparatus is provided. A first slurry is formed that includes negatively charged granular conductive material and a fluid, and it is placed into a first receptacle. The first slurry is processed to remove cations from the negatively charged granular conductive material. The first slurry is then drained after cation removal. A second slurry that includes positively charged granular conductive material and a fluid is formed and is placed into the first receptacle. The second slurry is then drained through the first slurry to form combined slurries. Water is added to the combined slurries, it is heated and mixed to form a mixed slurry, and drained of all fluid. Treated water is added to the mixed slurry, which is heated and drained of all water whereupon it is transferred to a pressure vessel to await return to the electrode.

Optionally, an acid can be added to the first slurry to form a solution that has a pH within a predetermined range. The first solution is drained after the acid has reacted and prior to adding the second slurry to the first slurry.

In a further aspect of the present invention, a system for deionization of a fluid comprising is provided, the system including a treatment tank and a number of electrodes made in accordance with the present invention. The electrodes are preferably arranged within an interior of the treatment tank such that at least some of the electrodes are arranged with the substrates of adjacent electrodes facing one another and at least some of the electrodes are arranged with the first members facing one another but spaced apart so as to receive the fluid to be deionized.

Other features and advantages of the present invention will be apparent from the following detailed description when read in conjunction with the following drawings.

### BRIEF DESCRIPTION OF THE DRAWING FIGURES

The foregoing and other features of the present invention will be more readily apparent from the following detailed description and drawings of illustrative embodiments of the invention in which:

FIG. 1 is a schematic diagram of a fluid treatment system, such as a deionization system, that includes a fluid treatment loop and a regeneration loop;

FIG. 2 is a cross-sectional view of a fluid treatment tank with a plurality of electrodes arranged therein;

FIG. 3 is a side perspective view of one electrode for use in the fluid treatment tank;

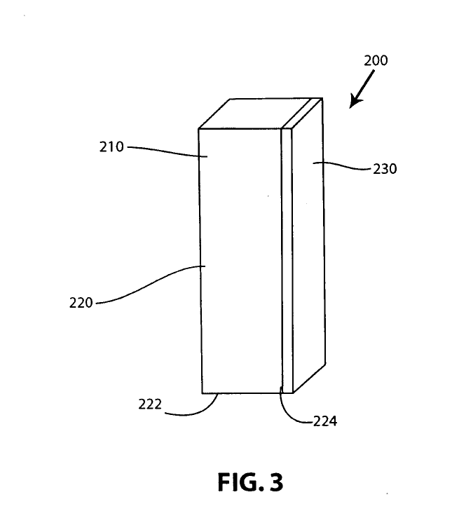

FIG. 4 is a side elevation view of a pair of electrodes with a fluid channel being defined between the electrodes;

FIG. 5 is a cross-sectional view of an electrode cell with an acid/caustic extraction system according to one exemplary embodiment of the present invention;

FIG. 6 includes graphs showing the performance of the fluid treatment system prior to including the ion removal system of the present invention;

FIG. 7 includes graphs for showing the performance over 150 runs of the fluid treatment system with the ion removal system of the present invention; and

FIG. 8 includes graphs for showing the performance over 150 runs of the fluid treatment system with the ion removal system of the present invention.

### DETAILED DESCRIPTION

It will be appreciated that while the disclosed porous electrode formed of a conductive porous carbon material (e.g., granular carbon material) has utility as a component of a water deionization system, the present invention is not limited to this particular type of application and can be used for treatment of fluids other than water streams. For example, chemical treatments, including distillation processes, that include a deionization step are also suitable applications for the system and method of the present invention. In addition, the ion removal (acid/caustic extraction) system according to the present invention similarly has other applications beyond water treatment and more particular and as described below in detail, the ion removal system can be used in any liquid deionization treatment process where a porous electrode is used.

In accordance with the present invention, an exemplary electrochemical separation system 100 is illustrated and includes the use of electrodes 200 that are formed of conductive carbon materials and in particular, the electrodes are formed in such away that the electrode has a porous structure and includes interstitial spaces (areas) between the porous material (particles) that forms the electrode itself.

For example, the one or more electrodes 200 that are used in the electrochemical separation system 100 can be formed of any conductive carbon material so long as the electrode contains interstitial spaces due to the material characteristics of the conductive carbon material. Suitable conductive carbon materials include but are not limited to activated carbons, graphite compounds, carbon nanotube materials, or the granular conductive carbon material that is disclosed in Applicants' '545 application.

According to one embodiment, the electrochemical separation system 100 includes a number of non-sacrificial electrodes 200 for removing charged particles, ions, contaminants and impurities from water, fluids and other aqueous or polar liquid process streams and its suitable applications. The electrode 200 is particularly suited for use in a deionization system 100 that includes a number of parallel arranged, upstanding electrodes 200. The system 100 can include a single type of electrode or the system 100 can be formed of more than one type of electrode 200 arranged in an alternating pattern within the system. For example and according to one deionization scheme, a single type electrode is used and arranged so that adjacent electrodes are oppositely charged for attracting particles of opposite charge. It will be understood and appreciated that the illustrated system merely illustrates one use of the present electrode and there are a great number of other uses for the electrode, including other deionization applications as well as other types of applications.

The electrode 200 can be used in a flow-through, flow by, or batch system configuration so that the fluid can utilize a charged surface area for attracting oppositely charged ions, particle, etc. It is also possible for a frame to be disposed around the electrode 200 to provide structural support around the perimeter of the electrode.

The system can be constructed in a number of different manners and the electrodes can be arranged in any number of different patterns within the apparatus. For example, U.S. Pat. Nos. 5,925,230; 5,977,015; 6,045,685; 6,090,259; and 6,096,179, which are hereby incorporated by reference as though set forth in their entirety, disclose suitable arrangements for the electrodes contained therein. As stated above, in one embodiment, the system includes a number of conductive, non-sacrificial electrodes that each is in the form of a structure of arranged members that together forms a deionization cell. During operation, a voltage potential is established between a set of adjacent electrodes. This is accomplished by connecting one lead of a voltage source to one of the electrodes and another lead is attached to the electrodes that are adjacent to the one electrode so as to produce a voltage potential there between. This can result in adjacent electrodes being charged oppositely. However, it is to be understood that the above-mentioned electrode embodiment is merely exemplary in nature and not limiting of the present invention since the present invention can be manufactured to have a number of designs besides an electrode formed of distinct members or materials that are arranged relative to one another.

When the electrode 200 is in made up of granular conductive carbon material, it can be and is preferably formed in accordance with the steps described in detail in Applicants' '545 application. In other words, a polymerized pre-form is first made, then carbonized and processed to form the conductive carbon material used in the final electrode. This type of electrode 200 is formed so that it does not require the use of a fiber reinforcer, which is typically in the form of a carbon source, such as carbon felt, paper, or fiber or a carbon/cellulose mixture.

As used herein, the terms “granular conductive carbon material” and “granular conductive material” refer to a particulate matter that can be ground carbonized blank material or it can be another carbon-based particulate conductive material. Preferred granular conductive carbon materials are those materials that will neither sacrifice in an electrical field nor dissolve in water and poses the ability to remove ions from solution when electrically charged.

While in one embodiment, the granular conductive carbon material is formed by first creating the carbonized absorptive material and then processing it so that it is broken into smaller particles, it will be understood that in another embodiment, a granular conductive carbon material possessing the specific characteristics necessary to deionize water could be commercially purchased and then used. As a result, certain activated carbons and even glassy carbon structures could produce satisfactory results in certain applications. It will also be appreciated that other materials which form electrically conductive chars such as coconut shells or coal based activated carbons which can be carbonized and broken down into a powder or granular form can be used in some applications as the granular conductive material.

However, it will be clearly understood that the use of granular conductive carbon material to form the electrode 200 is merely one technique to form an electrode that has interstitial spaces and a number of other materials, such as those listed above, and processing techniques can be used to form the electrode 200 having a porous structure.

The electrode 200 is an electrically conductive, homogenous, porous carbon structure that functions as part of an absorptive electrode structure that is utilized in a deionization system that is constructed to remove ions from a liquid when an electric current is applied.

As previously mentioned, the steps and operating conditions for manufacturing the electrode 200, when it is formed of granular conductive carbon material, are disclosed in detail in Applicants' '545 application.

One exemplary electrode 200 is formed of three members or materials or layers that are disposed in relation to one another, namely, a substrate 210, a member 220 that is formed of porous conductive carbon material, such as the above described granular conductive material, and a barrier member 230, with the conductive carbon material 220 being disposed between the substrate 210 and the barrier member 230. The electrode 200 can take any number of different shapes and sizes and according to one embodiment; the electrode 200 has a square or rectangular shape. However, these shapes are merely exemplary and illustrative in nature and any number of other regular and irregular shapes can be used. The electrode 200 has a shape and dimensions that are complementary to the shape and dimensions, respectively, of a fluid treatment tank where the fluid (e.g., waste water) is introduced for treatment (e.g., deionization) thereof.

It will be appreciated that while the thicknesses of the members 210, 220 and 230 can be the same, the members typically have different thicknesses.

The electrode 200 is generally disposed in an upright manner within the interior of the fluid treatment tank such that a bottom edge 201 of the electrode 200 seats against a floor of the tank according to one embodiment. The members 210, 230 can be fixedly mounted in the interior of the tank such that the two are mounted in an upright manner with a predetermined distance defined therebetween so as to provide the space that receives the porous conductive carbon material. In this embodiment, the sides of the electrode 200 face and are opposite respective sides of the fluid treatment tank. The electrodes 200 can be arranged in a number of different ways to define a number of different flow paths for the fluid that is introduced into the tank for treatment thereof by means of the electrodes 200. In the illustrated embodiment, a plurality of electrodes 200 are arranged side-by-side along the length of the fluid treatment tank, with the barrier members 230 of one set of adjacent electrodes facing one another, while the substrates 210 of some of the electrodes 200 face substrates 210 of other electrodes 200. In other words, the electrodes 200 are arranged in pairs that are arranged back-to-back in that the substrates 210 of one pair face another with a first space 240 (vertical space or vertical channel) formed therebetween for receiving a device 260 that compresses the electrode 200 as described below. The barrier members 230 of this pair face barrier layers 230 associated with two different pairs of electrodes 200 such that between opposing barrier members 230 of two electrodes 200, a second space 250 (vertical space or vertical channel) is formed to permit the fluid that is being treated and introduced into the fluid treatment tank to flow as described below. The width of the first space 240 can be different from the width of the second space 250; however, the precise relationship between these dimensions can be varied from application to application.

The substrate 210 serves as a backbone to the layered electrode structure 200 and can be formed of any number of different non sacrificial conductive materials. For example, the substrate 210 can be formed of graphite; any steel composition that is non-sacrificial and electrically conductive; conductive polymers, epoxies, plastics or rubber; and any non-ferrous materials that are non-sacrificial and electrically conductive, such as gold, silver, platinum, titanium, aluminum, etc.

Depending upon the type of treatment and other parameters, such as the relative dimensions of the treatment tank and the quantity of fluid that passes through the tank per unit of time, etc., the physical and electrical properties of the substrate 210 will vary. For example, the substrate 210 can have an area from about 0.001 square inch to in to greater than 10,000 square inches, the width of the substrate 210 can be from about 0.001 inch to greater than 1 inch and the bulk resistance of the conductive material that forms the substrate 210 can be between about 0.1 milliohm to about 10 ohms.

In the illustrated embodiment, the substrate 210 has a plate-like form that can come in any number of different shapes, such as a square or rectangle, and different sizes.

Preferably and according to one embodiment, each of the electrodes 200 has the same dimensions, as well as the same physical and electrical properties so as to provide a uniform electrode arrangement.

When the conductive carbon material is in the form of granular conductive carbon material, as disclosed in the '545 application, the particle size of the granular conductive material is preferably between about 1 to about 500 microns in one embodiment, with one exemplary range being from about 40 microns to about 120 microns. For example, the granular conductive material can have an average particle size of greater than 50 microns but less than 100 microns or it can be between about 100 microns and about 120 microns. The granular conductive material can thus be thought of as free flowing powder-like substance that has different properties, depending upon the precise particle size thereof, and the operating conditions.

Since the member 220 is in the form of granular conductive material, this material has a high degree of flow and can easily flow along a path when a force is applied thereto or under gravitational forces. In other words, the granular conductive material is highly fluidic in nature and this permits the electrode material (granular conductive material) to be easily flushed from the fluid treatment tank. More specifically, a slurry formed of a fluid, such as water, and the granular conductive material 220, can have a number of different viscosities that are conducive to easily flowing within a regeneration loop to permit regeneration of the granular conductive material 220 in a regeneration tank and permit delivery of the regenerated electrode material back into member 220 of the electrode 200 that is contained in the fluid treatment tank.

The granular conductive material 220 has an associated pore size that can be in a range from about 10 to about 100 μmÅ and can have a surface area between about 400 to about 1200 m²/g (BET).

It will be appreciated that even when other materials besides the above-described granular conductive carbon material are used to form the member 220 of the electrode 200, all these materials have a degree of porosity and form a porous structure (member 220) that contains interstitial spaces.

The barrier member 230 can take any number of different forms including a structure that is formed of a porous material that permits the fluid (e.g., water) flowing within the second space 250 to flow through and into contact with the conductive carbon material of member 220. The barrier member 230 can also be formed of a non-porous material (e.g., polyethylene (PE)) that is formed as a sheet that includes a number of through openings so as to form a grid like pattern, with the fluid flowing through these openings and into contact with the conductive carbon material of member 220.

When the barrier member 230 takes the form of a porous member, the barrier member 230 can be formed of any number of different materials so long as they have a sufficient degree of porosity to permit fluid that flows within the second space 250 to flow therethrough and into contact with the conductive carbon material that makes up the member 220. The porosity of the member 230 can vary from application to application; however, according to one embodiment, the porosity of the member 230 is between about 1 μm and about 5000 μm. As with the other members, the barrier member 230 can be provided in different widths, such as, for example, between about 0.001 inch and 2.00 inches.

It will be appreciated that since the barrier member 230 is disposed against one face of the conductive carbon material member 220, it acts as a barrier to prevent the granular material from moving into the second space 250. Thus, the particle size of the granular conductive material and the pore size of the barrier member 230 are selected such that the pore size of the barrier member 230 prevents the granular conductive material from being able to travel through the pores (openings) formed through the barrier member 230.

The porous barrier member 230 can be formed of any number of different types of porous materials, which are preferably, but not necessarily, non-conductive in nature or the barrier member 230 can be formed of non-conductive materials that can be formed as a grid like structure. For example, the barrier member 230 can be formed of a material selected from the group consisting of a porous plastic (e.g., PE, Derlin, UHMW, HDPE, Nylon, Polycarbonate, etc.); a mesh formed of polyester, nylon, etc.; a non-conductive carbon foam; a non-conductive ceramic foam, etc. The barrier member 230 has a geometry that complements the structure 220 formed of conductive carbon material.

It will also be understood that the barrier member 230 can be in form of a plastic or synthetic cloth-like structure and can have any number of different constructions, such as a honeycomb structure.

In its operative state, the porous conductive carbon material 220 is in a compressed form or state in that the device 260 is provided for applying a predetermined compressive force to the porous conductive carbon material 220 so as to cause the loose, free porous conductive carbon material to assume a more compact, defined layer or structure. When compressed, the thickness of the member of the porous conductive carbon material is reduced and in one exemplary embodiment, the member 220 of porous conductive carbon material has a thickness between about 0.010 inch and about 1 inch; however, these values are merely exemplary and depending upon the particular application, the member 220 can have a thickness outside of this range.

Even in the compressed state, the member 220 formed of porous conductive carbon material still has interstitial spaces.

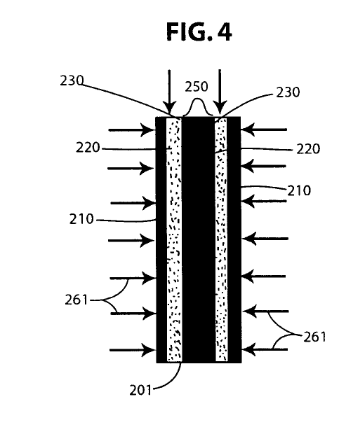

The conductive carbon material can be compressed by applying pressure either in a horizontal direction or by applying pressure in a vertical direction against and with respect to the conductive carbon material. In FIG. 4, arrows 261 show compression being applied in a horizontal direction.

The device 260 can take any number of different forms so long as it is configured to apply a positive pressure (compressive force) to the member 220 of the conductive carbon material and preferably, the device 260 is constructed to apply positive pressure along the length (height) of the member 220.

Moreover, it will be appreciated that the compression of the conductive carbon material can occur from any or all sides of the material (member 220).

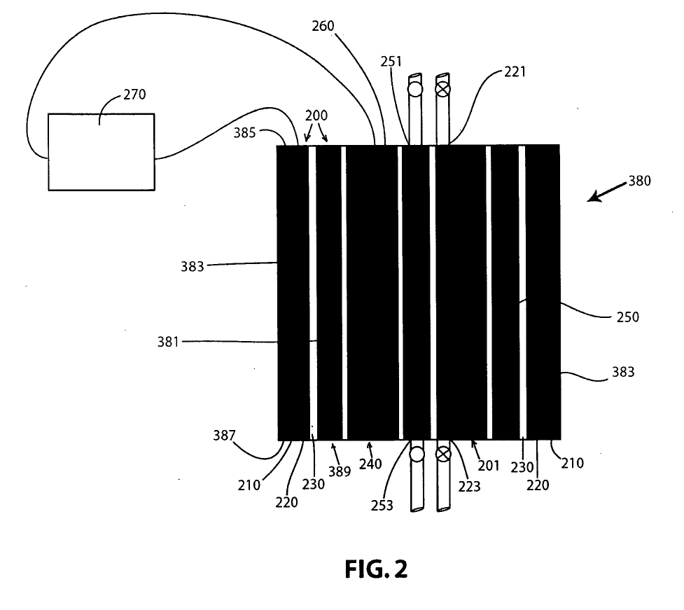

It will be understood and as illustrated in FIG. 2, the first space 240 formed between two opposing substrates 210 is for receiving the compression device 260 so that when actuated, the device 260 expands and applies a pressure to the opposing substrates 210. Preferably, the force is applied in a direction that is substantially perpendicular to the exposed faces of the substrates 210. Since fluid, such as water or a chemical solution, is contained in the second spaces 250 along with a rigid structure constructed of either porous plastic or a hollowed out plastic structure, a force is applied by the fluid and structure against the exposed faces of the barrier members 230, thereby causing the conductive carbon material to be effectively sandwiched between the other two members 210, 230. In other words, the water and rigid structure offers a high degree of resistance to movement of the electrode 200 in a direction of the force applied by the device 260 and this permits the granular conductive material to be contained in a well defined member 220 as part of the electrode 200 despite the granular conductive material having a relatively high degree of velocity. The substrates 210 of the electrodes 200 that are located adjacent the end walls of the fluid treatment tank are supported directly by the end walls and there is no need of a compression device 260 adjacent to these surfaces.

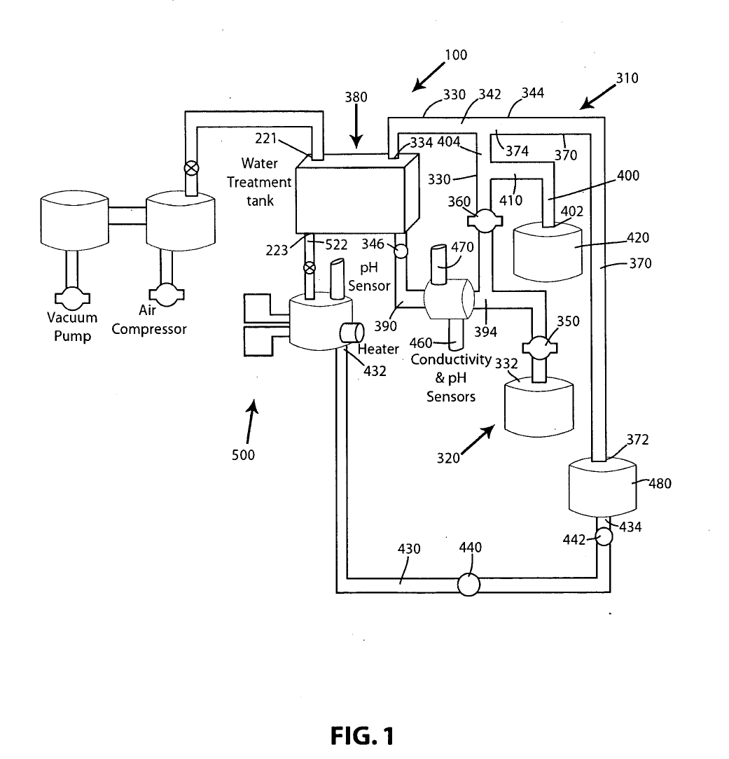

Now referring to FIGS. 1-2, a system 100 for deionization of a fluid is illustrated and generally includes a fluid treatment circuit or loop 310 for treating a fluid, such as waste water, so as to deionize and otherwise treat the fluid to produce treated water that can be discharged to some other location. The fluid treatment circuit 310 includes a source of fluid 320 that is to be treated and in one embodiment, the fluid 320 is process water that contains unwanted matter, such as different ions, metals, etc. However, the fluid 320 can be any number of different fluids other than water, and, for example, the fluid can be a chemical fluid stream or a liquid chemical batch. The source of fluid 320 can be in the form of a storage container, receptacle or tank that stores a predetermined volume of fluid and can be operatively coupled to an inlet line that delivers process fluid to the tank. In this manner, once a first batch of fluid is delivered to and through the fluid treatment circuit 310, a next batch of fluid is then delivered for storage in the receptacle. For example, the inlet line can be in the form of a fluid conduit (e.g., tube) that delivers the fluid, in a controlled manner, to a location where the fluid is treated. It will be appreciated that the size (volume) of the receptacle that holds the fluid will vary depending upon the precise application and depending upon how much fluid is to be treated.

It will be understood that as used herein the term “conduit” can refer to a separate and distinct member that carries fluid from one location to another or it can refer to a demarcated segment or section of a single continuous conduit. In other words, while the below discussion describes a number of different conduits, one or more of the conduits may define a single continuous flow path.

The fluid treatment circuit 310 also includes a first conduit 330 that includes a first end 332 that is fluidly attached to the fluid source 320 and an opposite second end 334 that is fluidly connected to a fluid treatment receptacle (tank) 380 where the fluid from source 320 is treated by means of operation of the electrodes 200, as described herein, that are arranged in the receptacle 380. The first conduit 330 can be in any number of different forms but typically is in the form of tubing, such as PVC tubing, that is designed to carry the type of fluid that is being treated without any damage or weakening of the tubing itself. As illustrated, the first conduit 330 can be defined by a number of different tube sections that are formed at angles relative to other tube sections or the first conduit 330 can be for the most part a linear conduit that extends between the receptacle 380 and the source 320.

The first conduit 330 has a number of valve members that are associated therewith for controlling the flow direction (fluid pathway or route) and/or the flow rate of the fluid as it flows from the fluid source 320 to the receptacle 380. For example, the first conduit 330 can include a first valve member 340 that is located along the first conduit 330 closer to the first end 332 thereof and a second valve member 342 that is located within the first conduit 330 further downstream from the first valve member 340 and closer to the second end 334 that is fluidly attached to the receptacle 380.

As will be appreciated below, the first and second valve members 340, 342 can be any number of valve members that are operable to permit or restrict flow of fluid within one or more sections of the first conduit 330 so as to either isolate the first conduit 330 from other conduits or permit fluid communication between the first conduit 330 and other conduits or other system components, such as the fluid treatment receptacle 380. The valve members 340, 342, as well as other operative components of the system, are preferably in communication with a controller (processor) or the like, which permits the individual valve members 340, 342 to be selectively controlled and placed into a desired position, such as a fully opened position or a closed position.

The system 100 also has a number of pumps or the like that are associated therewith for selectively and controllably routing fluid along a desired flow path. For example, the first conduit 330 can include a first pump 350 and a second pump 360 that are operably connected and in communication with a controller, such as a master controller or processor, that permits each pump to be independently controlled. The first pump 350 is preferably disposed closer to the first end 332 near the source of process fluid 320 and preferably upstream of the first valve 340. The first pump 350 thus acts as a primary means for withdrawing the fluid from the source 320 and then directing it along the first conduit 330 to another location or another conduit.

The second pump 360 is disposed downstream of both the first pump mechanism 350 and the first valve 340. The second pump 360 can be operated to further direct the fluid along the first conduit 330 or recirculate fluid in and out of the treatment box 380 for quality testing at the pH and conductivity sensors.

The system 100 also includes a second conduit 370 that has a first end 372 that is in fluid communication with a treated fluid receptacle 380 that is intended to store the fluid that has been treated in and discharged from the fluid treatment receptacle 380. An opposite second end 374 of the second conduit 370 is in fluid communication with the first conduit 330 and in particular, a third valve member 344 is provided where the second conduit 370 joins the first conduit 330. Thus, the third valve member 344 serves to selectively open and close the second conduit 370 with respect to the first conduit 330. The second valve member 342 and third valve member 344 can be disposed on opposite legs of a T-shaped fluid intersection between the first and second conduits 330, 370 such that when the third valve member 344 is closed and the second valve member 342 is open, the fluid from the process fluid receptacle 320 can flow through the first conduit 330 and into the fluid treatment receptacle 380. This is the case when the process fluid (e.g., process water) is to be initially delivered to the fluid treatment receptacle 380 for treatment (e.g., deionization) thereof.

The system 100 also includes a third conduit 390 for recycling water being treated in box 380 past sensors to determine treatment condition that has a first end 392 that is fluid connected to an outlet port of the fluid treatment receptacle 380 for receiving fluid therefrom and an opposite second end 394 that is in fluid communication with the first conduit 330 at a location that is downstream of the first valve 340 to permit fluid from the fluid treatment receptacle 380 to be selectively routed from the third conduit 390 to the first conduit 330 past quality sensors 370 through pump 360 back into treatment box 380. Since the third conduit 390 is in fluid communication with the first conduit 330 at a location downstream of the first valve 340, closure of the first valve 340 permits the fluid from the fluid treatment receptacle 380 from being delivered to the source of process fluid 320 since this fluid in the third conduit 390 can be treated fluid that is to be carefully stored and not mixed with any fluids that could recontaminate the fluid.

The third conduit 390 also includes at least one valve and in particular, the third conduit 390 includes a fourth valve 346 that is located at or near the first end 392 thereof. The fourth valve 346 is thus disposed near the outlet port of the fluid treatment receptacle so that when the fourth valve 346 is closed, the fluid in the fluid treatment receptacle 380 is prevented from flowing into the third conduit 390 and thus, remains in the fluid treatment receptacle 380 as when it is desired for processing the fluid. In contrast, when the fourth valve 346 is opened, the fluid that is within the fluid treatment receptacle 380 is free to flow into the third conduit 390 and then be routed along a desired flow path.

The third conduit intersects the first conduit 330 downstream of the first valve 340 but upstream of the first pump 350 such that operation of the first pump 350 causes the fluid in the third conduit 330 to be drawn into the first conduit 330.

The system 100 can also include a fourth conduit 400 that has a first end 402 that is fluidly connected to a fluid waste receptacle 420 and an opposing second end 404 that is in fluid communication with the first conduit 430. The fourth conduit 400 is thus configured to selectively receive waste fluid from the first conduit 430 generated during the electrode fill cycle. The fourth conduit 400 has a fifth valve 410 associated therein for either permitting fluid communication between the first and third conduits 330, 400 as when the valve 410 is open or preventing fluid communication therebetween as when the valve 410 is closed. The valve 410 is thus preferably located at or near the point where the third conduit 400 is fluidly connected to the first conduit 330. The second pump 360 that is used for recirculation is thus located between the first valve member 340 and the fifth valve member 410.

The location where the fourth conduit 400 is in selective communication with the first conduit 330 is downstream of where the third conduit 390 is in selective communication with the first conduit 330 but is upstream of where the second conduit 370 is in selective communication with the first conduit 330.

A fifth conduit 430 is provided and has a first end 432 that is in communication with a component of the regeneration system (loop) 500 and an opposing second end 434 that is in fluid communication with the treated fluid receptacle 480. The fifth conduit 430 thus provides a direct link between a regeneration loop 500 and the receptacle 480 where the treated fluid is stored.

The fifth conduit 430 preferably includes a third pump 440 that is disposed along its length and similar to the other pumps is preferably operably connected and in communication with the master controller such that the third pump 440 can be selectively controlled to cause selective operation and pumping of the fluid that is within the fifth conduit 430. A sixth valve member is disposed in the fifth conduit 430 and operates in the same manner as the other valve members.

A number of control and sensor components can be provided for monitoring different physical characteristics and parameters of the fluid at selected locations along the fluid loop 310.

In the illustrated embodiment, the system 100 includes a conductivity sensor 460 and a pH sensor 470 are both located within the third conduit 390 to permit the fluid that is discharged from the fluid treatment receptacle 380 through the third conduit 390 to be monitored before it is delivered into the first conduit 330 for delivery to another location, such as the treated fluid receptacle 480. It will be understood that the sensors 460, 470 can be of a different type depending upon the precise type of fluid treatment.

The present invention also includes the regeneration loop 500 for regenerating the electrodes 200 as described in detail in the '545 application.

The fluid treatment tank 380 contains a number of electrodes 200 that are arranged according to a predetermined pattern within an interior 381 of the fluid treatment tank 380. FIG. 2 shows the components that are placed within the interior 381 of the fluid treatment tank 380 and in particular, shows an arrangement of electrodes 200. More specifically, the fluid treatment tank 380 is defined by a wall structure 383, which in the case of a rectangle is defined by opposing end walls and opposing side walls. The fluid treatment tank 380 includes an upper edge 385 that defines a ceiling or roof that can be closed off using roof plate or the like or it can remain fully open or at least partially open depending upon the application. The fluid treatment tank 380 includes an opposite lower edge 387 that is defined by a floor 389. The one or more inlet ports of the fluid treatment tank 380 are formed along the upper edge 385 and can be formed through the roof plate or the like to permit both receipt of the regenerated electrode material, as described below, as well as receipt of the fluid that is to be treated (e.g., deionized) in the fluid treatment tank 380. The one or more outlet ports of the fluid treatment tank 380 are formed along the floor 389 to permit discharge of both the electrode material that is in need for regeneration and the fluid that has been successfully treated within the fluid treatment tank 380.

The fluid treatment tank 380 is also designed so that each of the second spaces 250 has an associated inlet port 251 for receiving fluid that is to be treated and an associated outlet port 253 that permits the fluid to be discharged from the tank 380. As best shown in FIG. 2, the inlet port 251 can be formed at the upper edge of the tank 380, while the outlet port 253 for each second space 250 can be formed in the floor 389 of the tank 380. As previously mentioned, there are valve members associated with each of the inlet line and the outlet line to permit control over the flow of fluid (e.g., water) into the second spaces 250 and control over the discharge of treated fluid from the tank 380. By having all of the valve members operatively connected to a master controller, all of the valve members can be opened or closed simultaneously to either cause a filling of the tank 380 or a flushing of the tank 380 when the fluid treatment is done in a batch like manner.

Similarly and as illustrated in FIG. 2, each of the members 220 has an inlet port 221 associated therewith for receiving the porous, conductive carbon material into the tank 380 and an outlet port 223 associated therewith for discharging the granular conductive material from the tank 380. The inlet port 221 and outlet port 223 are part of the regeneration loop 500 and as with the water loop, the inlet ports 221 and outlet ports 223 have valve members associated therewith to permit selective and controlled delivery of the granular conductive material to the spaces 250 of the tank 380, as well as discharge therefrom when regeneration of the electrode material is needed or desired.

Since the substrate 210 of the electrode 200 is conductive in nature, it is intended to be operatively and electrically connected to the power supply 270 (DC power supply). More specifically, one polarity (+) or (−) of the power supply 270 is connected to the substrate 210 for charging the substrate 210 according to this one polarity. In contrast, the barrier member 230 is formed of a non-conductive material so that it provides a non-conductive interface. Since the granular conductive material 220 abuts and is in direct contact with the substrate 210, along a length thereof, a charge that is delivered to the substrate 210 is also delivered to the granular conductive material 220. In this manner, the electrode material in the form of the granular conductive material 220 is charged as a result of operation of the power supply 270.

As can be seen in FIG. 2, alternating substrates 210 are connected to opposite polarities of the power supply 270 throughout the tank 380. In this manner, the fluid (e.g., water) in the second space or channel 250 is in contact with two electrodes 200 of opposite polarity to permit deionization thereof in one preferred operation using the electrodes 200.

The porous conductive carbon material 220 that forms a part of the electrode assembly 200 has an associated resistance value that is inversely proportional to compression of the conductive carbon material 220 by means of the compression device 260 and is directly proportional to the particle size (average particle size) of the conductive carbon material 220. In one embodiment, the resistance of the conductive carbon material 220, as measured from the first surface 222 adjacent to the conductive substrate 210 to the second surface 224 adjacent to the porous non-conductive barrier member 230, is from about 0.1 milliohm to about 10 ohms. However, it will be appreciated that the above values are merely exemplary and illustrative in nature and is not limiting of the scope of the present invention since the resistance of the conductive carbon material 220 may lie outside of this range. It will also be appreciated that the conductivity of the conductive carbon material varies depending on a number of different parameters, including the degree of pressure that is being applied to the carbon material and the particle size of the porous carbon material.

The width of the second space 250 can vary depending upon the precise application and other factors, such as the size of the tank 380 and the overall fluid processing requirements of the tank 380 per unit of time. According to one embodiment, the width of the second space 250 (and thus the width of the fluid) is between about 0.01 inches and 6.00 inches; however, other widths are equally possible.

The electrical connection between the power supply 270 and the substrates 210 can be accomplished using any number of conventional techniques. Regardless of the exact specifics of the electrode 200, when it is used in a deionization apparatus, the conductive carbon material must be supplied with a voltage. This can be done with a rod or wire, such as formed from copper or other conductor that is attached directly to the substrate 210 or to the conductive carbon material 220. However, if the rod or wire is exposed to the liquid being deionized, the rod or wire will be damaged (by being sacrificed). Therefore, a dry connection between the rod or wire and the plate is preferably established.

A dry connection can be made between the substrate 210 of the electrode 200 and a conductor, preferably an insulated copper wire, in the manner described in the '545 application.

It will be understood that the control system (master controller or processor) can be essentially identical to or similar to the control system that is disclosed in International patent application Serial No. PCT/US2005/38909, which is hereby incorporated by reference in its entirety.

In addition, the system 100 can be designed so that instead of being designed as a batch type fluid treatment process, the system includes staged fluid treatment tanks 380, with the fluid (water) flowing through several stages, with each stage performing partial treatment. The stages can vary in cell spacing (spacing of the electrodes 200) and/or in applied power levels. In addition, the system can be designed so that a continuous flow of fluid (water) through the parallel treatment cells. Also, the fluid (water) can be designed to flow along a serpentine shaped flow path through the treatment cells, two or more of which are arranged in series with one another. The serpentine flow can include variable spacing between the cells (electrodes) and/or different power levels from the beginning to the end of the treatment path.

In addition, the treatment tank 380 can have any number of different geometries, including but not limited to concentric circular layers and spiral-wound layers.

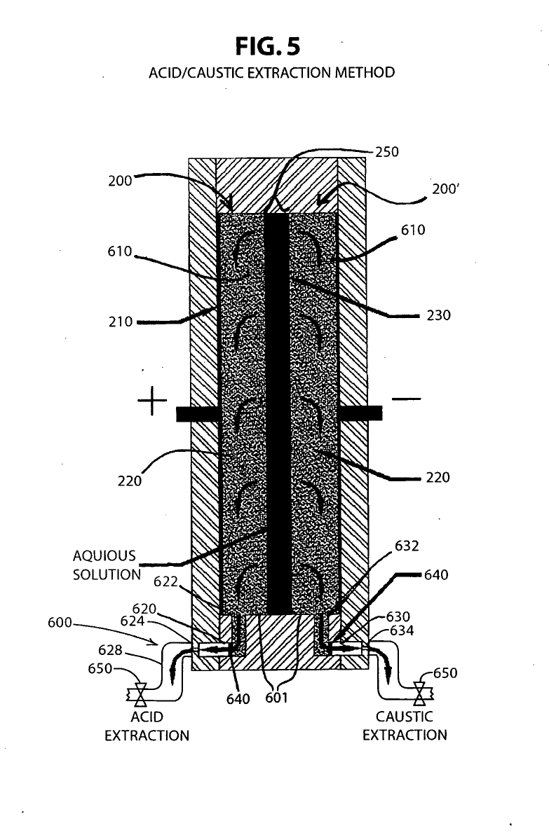

Now referring to FIG. 5, an ion removal (acid/caustic extraction) system 600 according to one exemplary embodiment of the present invention is illustrated. FIG. 5 shows one electrode cell 700 that is formed of two electrodes 200, 200′ that are spaced apart from another to create space 250 through which the fluid to treated flows. In the illustrated embodiment, the electrode 200 represents the anion removal side of the cell 700 since the electrode 200 is connected to a positive (+) terminal of a power source and conversely, the electrode 200′ represents the cation removal side since the electrode 200′ is connected to a negative (−) terminal of the power source.

The present Applicants have discovered that during operation of the system 100 (FIG. 1), ions are collected in the interstitial spaces, generally indicated at 610, in FIG. 5, that are formed between the conductive carbon particles that define the layer 220. In other words, the conductive porous material 220 includes interstitial spaces 610 and since the fluid that is to be treated flows within space 250 and into contact with the porous conductive material 220, the fluid enters the interstitial spaces 610 between the particles or granules of the conductive carbon material.

As the ions are attracted to the electrodes 200, 200′ (positive ions to the negative electrode 200′ and negative ions to the positive electrode 200) during the operation of the cell 700 and system 100 for that matter, the like charges of the ions increases to the point that the ions start repelling each other and the respective ions start attracting the oppositely charged H⁺ ion and OH⁻ ions. This results in an acidic solution within and near the negative ion removal side and a caustic solution within and near the positive ion removal side. In other words, as the ions collect within the interstitial spaces 610 defined in the electrode 200, the solution that baths the porous electrode material that forms the electrode 200 becomes acid in nature and similarly, as ions collect within the interstitial spaces 610 defined in electrode 200′, the solution that baths the porous electrode material that forms the electrode 200′ becomes caustic in nature.

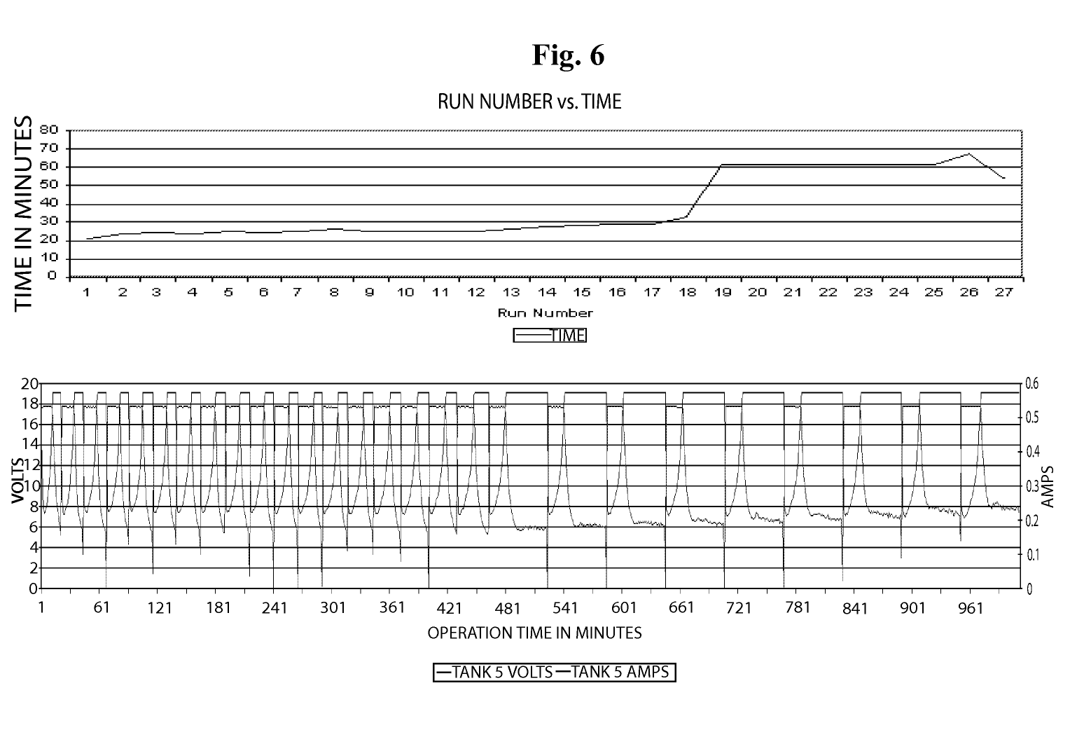

The caustic and acidic solutions increase in concentration and ionic strength as the system 100 is operated over time and the ions that are removed from the fluid flowing within space 250 are held and contained within the interstitial spaces 610 of the porous conductive carbon material 220 that forms the respective electrodes 200, 200′. The caustic and acidic solutions will concentrate on their respective sides until the electrical conductivity of the backplane (substrate 210) to solution (fluid flowing within space 250) becomes greater than the backplane (substrate 210) to porous conductive carbon material 220 pathway. When resistance of the backplane (substrate 210) to porous conductive carbon material 220 pathway becomes greater, the cell 700 of the system 100 stops removing ions and starts electrolyzing the highly conductive solution near the respective backplane (substrate 210). The maximum capacity of cell 700 in system 100 without the ion removal (acid/caustic extraction) system 600 of the present invention is shown in FIG. 6. As illustrated in FIG. 6, the forward operation of system 100 (i.e., the deionization of fluid flowing in space 250) suddenly increases in time and the total number of runs are limited when the system 600 is not employed and the concentration of acid and base are allowed to build up within the cell 700 over time. In other words, FIG. 6 shows the average time in minutes for each run and after 18 runs in this one particular example, there is a significant and sudden increase in the amount of time in minutes required to perform a single run.

In accordance with the present invention, each cell 700 includes an acid/caustic extraction or ion removal system 600 that is designed to reduce the ion build-up within the interstitial spaces 610 of both the positive and negative electrodes 200, 200′ of the cell 700. As shown in FIG. 5, the positive electrode 200 includes a first interstitial drain or outlet port 620 that has a first end 622 that is open to and in free communication with the layer 220 of porous conductive carbon material associated with the electrode 200. An opposite second end 624 is open to the exterior of the cell 700 and, as described below, can be connected to a conduit (tubing) 628 or the like to route the removed acidic solution (fluid) from the interstitial spaces 610. Similarly, the negative electrode 200′ includes a second interstitial drain or outlet port 630 that has a first end 632 that is open to and in free communication with the layer 220 of porous conductive carbon material associated with the electrode 200′. An opposite second end 634 is open to the exterior of the cell 700 and, as described below, can be connected to a conduit (tubing) or the like to route the removed acidic solution (fluid) from the interstitial spaces 610. The first and second interstitial drains or outlet ports 620, 630 can be incorporated into and formed in the housing that defines the cell 700 or they can be incorporated into and formed in a separate member that is coupled to the cell 700 so long as the fluid contained in the interstitial spaces 610 can flow into the first and second interstitial drains 620, 630.

It will be appreciated that the outlet ports 620, 630 thus allow the interstitial fluid to drain each of the porous conductive carbon material layers 220 that make up part of each electrode 200, 200′. It will also be understood that the outlet ports 620, 630 are constructed so that they are isolated and not in communication with the space 250 where the fluid to be treated flows so that the fluid that is removed via the outlet ports 620, 630 is the fluid that is contained in the interstitial spaces 610 and not from space 250.

Each of the interstitial fluid outlet ports 620, 630 can and preferably does include a filter member 640 that prevents the porous conductive carbon material 220 from draining from the cell 700 when the interstitial fluid is drained and removed therefrom in accordance with the present invention. The filter member 640 can be in the form of a porous membrane or screen or mesh material that permits the ion-containing interstitial fluid to flow therethrough but prevents the porous conductive carbon material (e.g., granular material) from passing therethrough when the system 600 is operated.

Each of the outlet ports 620, 630 or the conduit 628 attached thereto preferably has a control valve 650 to regulate the removal rate of the interstitial fluid. The control valve 650 can be electronically and operatively connected to a control unit (not shown) that permits remote control over the removal of the interstitial fluid, including the rate at which the interstitial fluid is removed from each electrode 200, 200′.

It will also be appreciated that while in one exemplary embodiment, each of the electrodes 200, 200′ includes an interstitial outlet port or drain, it is possible for only one of the electrodes 200, 200′ to include the interstitial outlet port or drain.

The actual manner or mechanism for removing the interstitial fluid from the respective electrodes 200, 200′ can be accomplished in any number of different ways using different techniques and equipment. For example and as shown in FIG. 5, the system 600 can operate be a gravity feed mechanism in that the outlet ports 620, 630 are positioned along and in communication with a bottom edge 601 of the porous conductive carbon material 220. Since the cell 700 is vertically oriented, the interstitial fluid will under normal operating conditions flow by gravity towards the bottom edge 601 of the material 220. Thus, by placing the first ends 622, 632 of the outlet ports 620, 630, respectively, at and along the bottom edge 601, the interstitial fluid will flow by gravity down the compact vertical layer of material 220 toward and into the respective outlet port 620, 630 where it is then removed from the cell 700.

Instead of a gravity feed mechanism, other mechanisms can be used. For example, the interstitial fluid being removed from the outlet port 620, 630 can be regulated by using an apparatus that creates a pressure differential resulting in the interstitial fluid being routed down the vertical layer of material 220 toward and into the outlet port 620, 630. This can be accomplished by exerting positive pressure on the interstitial fluid in one location or by creating a low pressure environment at the bottom edge 601. For example and according to one embodiment, a vacuum mechanism is used to withdraw the interstitial fluid from the material layer 220 of each respective electrode 200, 200′. A vacuum mechanism can be directly connected to ends 624, 634 of the outlet ports 620, 630 or the vacuum mechanism can be operatively connected to the conduits 628 that are fluidly connected to the outlet ports 620, 630.

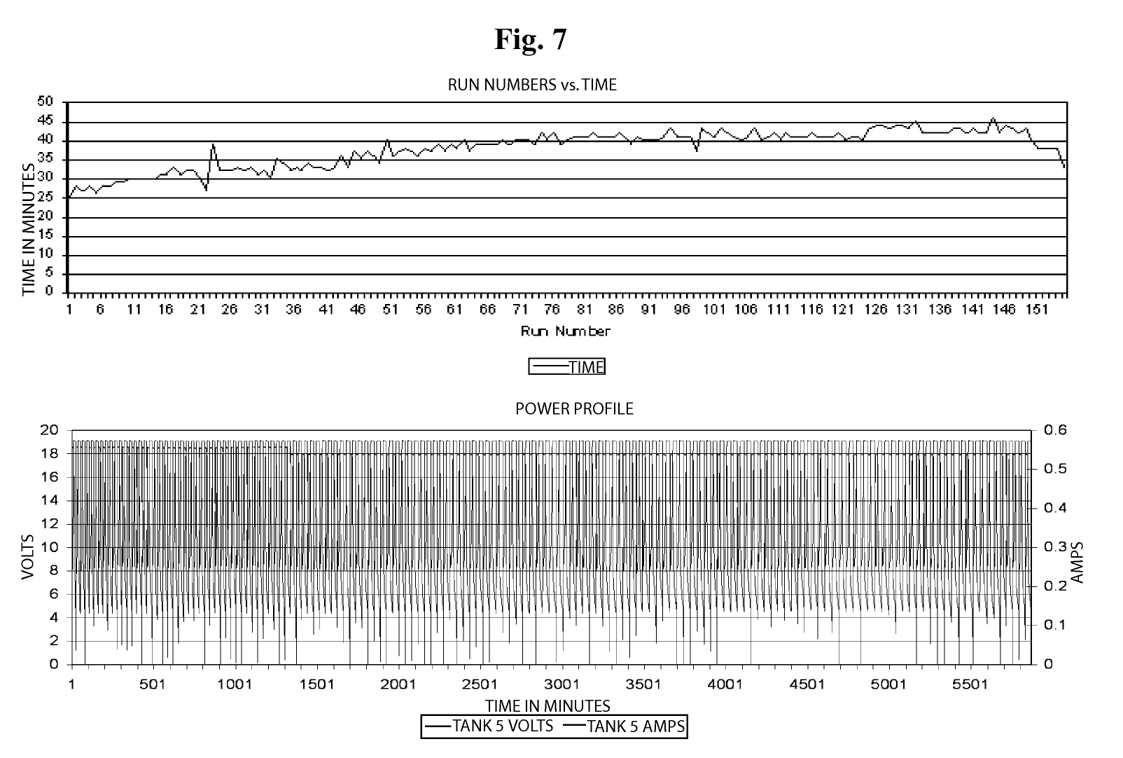

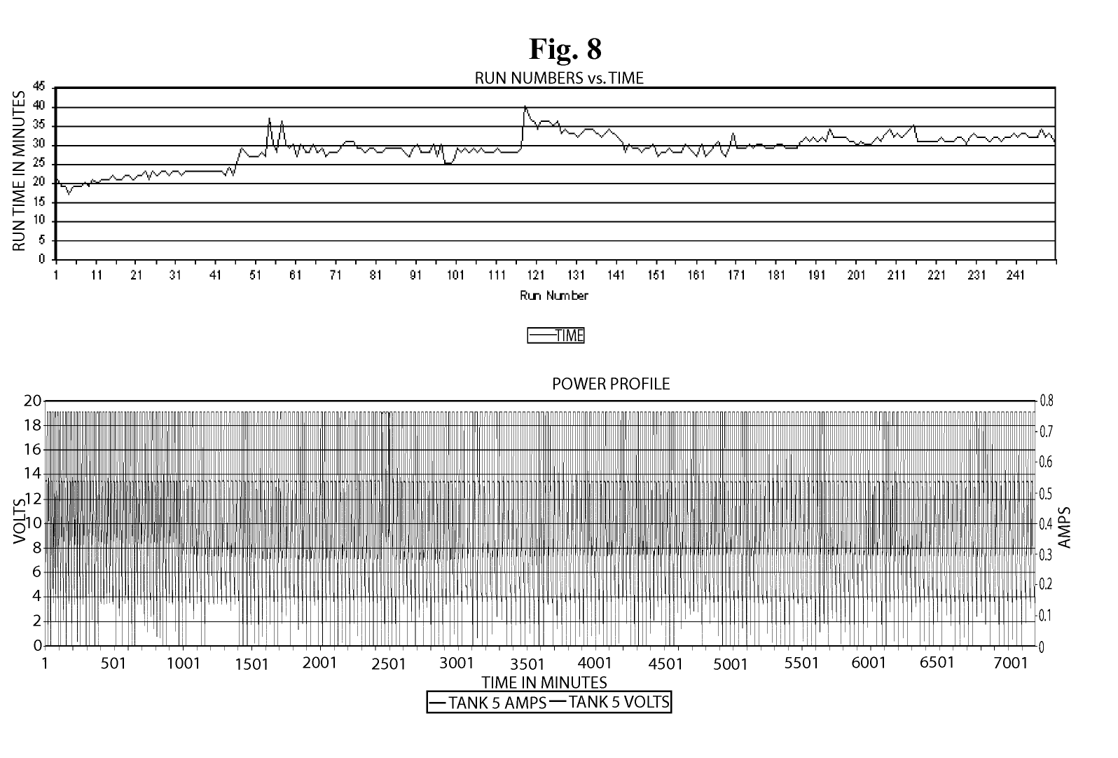

Applicants have discovered that the inclusion of the ion removal (acid/caustic extraction) system 600 with the system 100 provides a superior treatment system and substantially increases the efficiency and longevity of the treatment process. It has been determined that the removal of the interstitial fluid from interstitial spaces 610 of the porous conductive carbon material 220 during the forward deionization operation allows the cell 700 and system 100 to run for extended period of times before regeneration of the cells 700 is necessary. As mentioned above and with reference to FIG. 6, when the system 600 is not included, the system 100 is unable to reach the desired water quality after run 18. However and as shown in FIG. 7, when the acid/caustic extraction system 600 is added to the same fluid treatment system 100 used in the experiment of FIG. 6, there is a marked improvement. As shown in FIG. 7, the forward deionization operation was continued until 155 runs were completed and there was no evidence or showing that the system 100 was slowing in terms of average run efficiency or that the system 100 was in any way failing to operate. As shown in FIG. 8, the experiment was repeated again under the same conditions allowing the system 100 to run through 250 runs and once again, no slowing or failure of the system 100 is seen. Consequently, Applicants have discovered that there is a marked increase in performance of the system 100 when the interstitial fluid is removed from the cell 700 during operation.

When ions are removed from the cell 700 in the form of an acidic fluid (from electrode 200) or a caustic fluid (from electrode 200′), the conductivity of the solution near the respective backplane 210 continues to be less than the conductivity of the porous conductive carbon material 220, and the system 100 continues to run as shown in FIGS. 7 and 8 without any sudden increase in the average time required per each run. The draining of the interstitial fluid from a port (outlet ports 620, 630) positioned in communication with the layer of porous conductive carbon material 220 of each electrode 200, 200′ improves the overall performance and efficiency of the system 100 and provides necessary reagents for regeneration.

It will once again be understood that the ion removal system 600 and method of operation thereof can be used with any deionization scheme that uses electrodes that have a conductive material that has interstitial spaces. In other words, the ion removal system 600 is for use with electrodes that are formed with porous conductive carbon materials, such as the granular conductive carbon material disclosed in Applicants' '545 application or any other conductive carbon material that has material characteristics that result in interstitial spaces being formed when the carbon material is in its final form in the electrode. Other suitable conductive carbon materials include activated carbons, graphite compounds, etc. In addition, while water treatment is one example of where the fluid treatment system 100 can be used, the present invention is not limited to such application but can be used in any application where fluid deionization is performed.

What is claimed is:

1. An electrode for use in a deionization apparatus comprising:
a conductive material in a granular form and arranged in a layer defined by a first face and a second face;
a substrate disposed substantially against the first face; and
a first member disposed substantially against the second face and formed to permit a fluid to be treated to pass through the first member and into contact with the granular conductive material.

2. The electrode of claim 1, wherein the granular conductive material comprises:
a polymerization monomer;
a crosslinker; and
a catalyst,
wherein the polymerization monomer, crosslinker, and catalyst are in a carbonized form that is processed into a plurality of particles.

3. The electrode of claim 2, wherein the polymerization monomer comprises at least one material from the group consisting of dihydroxy benzenes; trihydroxy benzenes; dihydroxy naphthalenes and trihydroxy naphthalenes, furfural alcohol and mixtures thereof.

4. The electrode of claim 1, wherein the substrate is formed of a conductive material.

5. The electrode of claim 4, wherein the substrate comprises an electrically conductive plate.

6. The electrode of claim 1, wherein the substrate is formed of a material that is selected from the group consisting of graphite, electrically conductive steel, conductive polymers and electrically conductive non-ferrous metals.

7. The electrode of claim 1, wherein the granular conductive material is under compression between the substrate and the first member.

8. The electrode of claim 1, wherein the granular conductive material has a bulk resistance that is between about 0.1 milliohm to about 10 ohms.

9. The electrode of claim 1, wherein a width of the layer of granular conductive material is greater than a width of both the substrate and the first member.

10. The electrode of claim 1, wherein the granular conductive material has a particle size between about 40 microns and about 120 microns.

11. The electrode of claim 1, wherein the granular conductive material has a pore diameter that is in the range from about 10 A to about 1 OOA by BET or 0.0100 um to 1000 um by mercury penetrometer and a surface area between about 100 to about 1200 m²/g (BET).

12. The electrode of claim 1, wherein the first member comprises a structure formed of a porous material that permits the fluid to flow therethrough and into contact with the granular conductive material.

13. The electrode of claim 12, wherein a pore size of the porous material is less than an average particle size of the granular conductive material so as to prevent the granular conductive material from passing therethrough.

14. The electrode of claim 1, wherein the first member comprises a structure that has a plurality of through openings formed therein to permit the fluid to flow therethrough and into contact with the granular conductive material.

15. The electrode of claim 14, wherein the structure of the first member has a grid construction.

16. The electrode of claim 1, wherein the first member is formed of a non-conductive material.

17. A system for deionization of a fluid comprising:
a treatment tank; and
a plurality of electrodes according to claim 1 arranged within an interior of the treatment tank such that at least some of the electrodes are arranged with the substrates of adjacent electrodes facing one another and at least some of the electrodes are arranged with the first members facing one another but spaced apart so as to define a first space therebetween which receives the fluid to be deionized.

18. The system of claim 17, wherein the granular conductive material is in the form of loose particles that are held under compression in an operating mode of the system.

19. The system of claim 17, wherein each of the electrodes has a first inlet conduit for delivering the fluid into the first space and a first outlet conduit for discharging the fluid from the first space and a second inlet conduit for delivering granular conductive material to a location between the substrate and first member and a second outlet conduit for removing the granular conductive material.

20. The system of claim 17, wherein granular conductive material is placed under compression in an operating mode, with the compression being removed in a regeneration mode to permit the granular conductive material to flow viscously through the second outlet conduit, while the substrate and first member remain upstanding and spaced apart in the interior of the tank.

21. The system of claim 17, further including:
a power supply having a positive polarity and a negative polarity, wherein substrates of alternating electrodes are electrically connected to opposite polarities of the power supply so as to create a voltage potential across the first space.

22. The system of claim 17, wherein a second space is formed between the at least some of the substrates that face one another and an inflatable member is disposed within the second space for selectively applying pressure to the substrates to cause the respective layers of granular conductive material to be placed under compression when the inflatable member is inflated.

23. The system of claim 22, wherein the inflatable member is in the form of an inflatable bladder that extends along a substantial length of the substrate, wherein when inflated, the bladder applies a force to two spaced substrates and in turn, compression of the granular conductive material of the electrodes results.

24. The system of claim 17, further including:
a first fluid circuit for selectively delivering a process stream into the first spaces defined in the interior of the tank and selectively discharging the process stream after deionization thereof;
a second fluid circuit for selectively delivering the granular conductive material to a location between the substrate and first member of each electrode and for selectively removing positively and negatively charged granular conductive material from the fluid treatment tank for regeneration thereof.

25. The system of claim 24, wherein the second fluid circuit includes a regeneration tank that is maintained at predetermined conditions to permit regeneration of the granular conductive material by removal of charged ions attached to the positively and negatively charged granular conductive material.

26. The system of claim 25, further including:
a source of acid that is fluidly connected to the regeneration tank for selective delivery thereto;
a source of base (optional chemical ionic strength modifier) that is fluidly connected to the regeneration tank for selective delivery thereto;
a pH sensor for measuring a pH of the material within the regeneration tank and a heater for controlling a temperature within the regeneration tank; and
a master controller in communication with the sources of acid and base, the pH sensor and the heater to permit conditions within the regeneration tank to be controlled and maintained within a predetermined operating range.

27. The system of claim 24, further including:
means for moving the granular conductive material along the second fluid circuit from the treatment tank to the regeneration tank and then back to the treatment tank.

28. The system of claim 27, wherein the means operates by creating a pressure differential within the second fluid circuit for causing the controlled movement of the granular conductive material from one location to another location.

29. The system of claim 28, wherein the granular conductive material is part of a slurry that is moved along the second fluid circuit by operation of the means.

30. The system of claim 28, wherein the means includes a first device that creates positive pressure within the second fluid circuit and a vacuum device that creates negative pressure within the second fluid circuit.

31. The system of claim 24, wherein the first fluid circuit includes a first receptacle for holding the process stream that is to be deionized, a second receptacle that receives waste water and a third receptacle that receives deionized water, each of the first, second and third receptacles being fluidly connected to the treatment tank and including as associated valve member for selectively controlling flow of the process stream and the flow of waste water and deionized water from the treatment tank.

32. A process for forming an electrode comprising the steps of:
providing a first member and a second member;
forming a granular conductive material; and
disposing and containing the granular conductive material, in a loose particle form, between the first and second members, wherein the second member is constructed to permit fluid to pass therethrough into contact with the granular conductive material.

33. The process of claim 32, wherein the first member comprises a conductive plate and the second member is one of a layer of porous material and a perforated structure.

34. The process of claim 32, wherein the step of forming the granular conductive material comprises the steps of:
dissolving at least one polymerization monomer in a first crosslinker to form a first liquor;
maintaining the first liquor for a sufficient time and at a sufficient temperature until the first liquor forms a partially reacted 1 precursors polymer;
mixing the partially reacted liquor with a second crosslinker to form a mixed second liquor and maintaining the mixed second liquor for a sufficient time and at a sufficient temperature until the mixed second liquor polymerizes into a first solid blank;
firing the first solid blank at a sufficient temperature and for a sufficient time such that the first solid blank carbonizes into an electrically conductive member; and
processing the first solid blank, after the first block cools, so as to break up the carbonized blank into a granular carbon material;

35. The process of claim 34, wherein the polymerization monomer is selected from the group consisting of dihydroxy benzenes, dihydroxy napthalenes, trihydroxy benzenes and trihydroxy napthalenes, furfural alcohol and mixtures thereof.

36. The process of claim 34, wherein the first crosslinker and the second crosslinker are formaldehyde.

37. The process of claim 34, wherein the step of processing the first solid blank comprises the step of:
pulverizing the carbonized blank into the granular carbon material.

38. The process of claim 32, further including the step of:
compressing the granular conductive material between the first and second members.

39. The process of claim 38, wherein the step of compressing the granular conductive material includes the steps of:
forming a first space between the first members of adjacent electrodes;
inserting an inflatable member within the first space along the first members; and
inflating the inflatable member to cause compression of the granular conductive material.

40. A method of deionization of a fluid comprising the steps of:
arranging a plurality of first and second electrodes according to claim 1 within a fluid treatment structure;
positively charging the first electrodes and negatively charging the second electrodes; and
flowing the fluid within a space between the first members of adjacent first and second electrodes resulting in the fluid passing through the first member and into contact with the granular conductive material associated with the first and second electrodes.

41. A method of regenerating oppositely charged electrodes, each electrode being formed of a conductive material that is in a granular form and is arranged in a layer, a substrate that is disposed against the layer, and a first member that is disposed against the layer and is formed to permit a fluid to pass through the first member and into contact with the granular conductive material, the method comprising the steps of:
forming a first slurry that includes negatively charged granular conductive material and a fluid and placing it into a first receptacle,
processing the first slurry to cause removal of cations from the negatively charged granular conductive material;
draining the first slurry after cation removal;
forming a second slurry that includes positively charged granular conductive material and a fluid and placing it into the first receptacle;
draining the second slurry through the first slurry to form combined slurries;
adding process water to the combined slurries;
heating and mixing the combined slurries for a period of time to form a mixed slurry;
draining the mixed slurry of all fluid;
adding treated water to the mixed slurry;
heating and mixing the mixed slurry for a period of time;
draining the mixed slurry of all water and transferring it to a pressure vessel to await return to the electrode.

42. The method of claim 41, further including the steps of:
adding an acid to the first slurry to form a first solution that has a pH within a predetermined range; and
draining the first solution after the acid has reacted and prior to adding the second slurry to the first slurry.

43. The method of claim 42, wherein the acid comprises hydrochloric acid and the pH of the first slurry is maintained between 2.3 to 3.8 for between about 10 to 45 minutes.

44. The method of claim 41, wherein a temperature of the mixed slurries is maintained between ambient and 100 degrees centigrade for a duration of between about 1 to 8 hours.

45. The method of claim 41, wherein the first and second slurries are drained after heating.

46. The method of claim 41, wherein the treated water is added to the first and second mixture and heated and mixed for between about 1 to about 8 hours and the mixed first and second slurries are drained after heating.
